(19) United States
(12) Patent Application Publication
(10) Pub. No.: US 2013/0275218 A1
(43) Pub. Date: Oct. 17, 2013

(54) LOCATION-BASED WISH LIST

(71) Applicants: Alexandre Linares, Mountain View, CA (US); Steven McClelland, San Francisco, CA (US); Michael Metcalf, San Francisco, CA (US); Fernando Padilla, San Francisco, CA (US); Sarah Jean Sosiak, San Francisco, CA (US)

(72) Inventors: Alexandre Linares, Mountain View, CA (US); Steven McClelland, San Francisco, CA (US); Michael Metcalf, San Francisco, CA (US); Fernando Padilla, San Francisco, CA (US); Sarah Jean Sosiak, San Francisco, CA (US)

(73) Assignee: Yahoo! Inc., Sunnyvale, CA (US)

(21) Appl. No.: 13/449,172

(22) Filed: Apr. 17, 2012

(51) Int. Cl. G06F 15/16; G06Q 30/02

(52) U.S. Cl. 705/14.58; 709/217

(57) ABSTRACT

In one embodiment, the system obtains first information pertaining to one or more physical entities with respect to a user. The system creates or updates a profile pertaining to the user based, at least in part, upon the first information. The system provides second information to the user based, at least in part, upon the profile that has been created or updated.

### BACKGROUND OF THE INVENTION

The disclosed embodiments relate generally to methods and apparatus for providing content or advertisements to users based, at least in part, upon information pertaining to physical entities with respect to the users.

Geo-targeting is the method of determining the geographical location of a website visitor and delivering different content to that visitor based on his or her location, such as country region/state, city, zip code, organization, Internet Protocol (IP) address, Internet Service Provider (ISP), or other criteria. A common usage of geo-targeting is found in online advertising. Therefore, geo-targeting delivers content to visitors based upon the location of the searcher.

### SUMMARY OF THE INVENTION

The disclosed embodiments enable information pertaining to one or more physical entities to be associated with a user. This may be accomplished automatically or in response to user input. This information may then be applied to identify and provide content such as advertisements pertaining to the physical entities to the user.

In one embodiment, first information pertaining to one or more physical entities with respect to a user may be obtained. A profile pertaining to the user may be created or updated based, at least in part, upon the first information. Second information may be provided to the user based, at least in part, upon the profile that has been created or updated.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2 is a process flow diagram illustrating an example method of generating and implementing a wish list in accordance with various embodiments.

FIGS. 3A-3B are process flow diagrams illustrating example methods of serving advertisements according to user wish lists in accordance with various embodiments.

FIG. 4 is a process flow diagram illustrating an example method of bidding in accordance with various embodiments.

FIG. 5 is a schematic diagram illustrating an example embodiment of a network in which various embodiments may be implemented.

FIG. 6 is a schematic diagram illustrating an example client device in which various embodiments may be implemented.

FIG. 7 is a schematic diagram illustrating an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Geo-targeting is typically used to select, create, transmit, and/or otherwise provide advertisements to website users based upon their current location. The current location of website users may be determined based upon location data that the users have explicitly and/or implicitly provided to the website. More particularly, the location data may be obtained from account data provided by the users during registration or as a result of updating the account data after registration has been completed. For example, the account data may include a registration zip code, home location (e.g., address or portion thereof), and/or work location (e.g., address or portion thereof). Therefore, the account data for a particular website user may identify one or more locations of the website user. The current location of the website user may also be identified based upon signals explicitly transmitted by the user or implicit signals. Examples of implicit signals include an IP address of the website user, wifi triangulation, or Global Positioning System (GPS) location, which may be used to infer a current location, a home location, or a work location. As another example, the user's location may be implied through cell tower triangulation. A user may explicitly check in to a location via the use of a check in application, which may be accessed via a website and/or installed on a device such as a mobile device.

Geo-targeting typically focuses on location data explicitly or implicitly indicating the current location of the user. The assumption is that the user will likely take shopping action near the Normal Geographic Areas where the user spends the majority of their time. Normal Geographic Areas may include the user's home, work, school, etc. Furthermore, as will be described in further detail below, the disclosed embodiments may consider user behavior outside their Normal Geographic Area (NGA). Areas outside of the NGA may include a parent's home, vacation locations, business travel, etc.

Unfortunately, the content of the advertisements that the user receives are typically unrelated to the location of the user. Furthermore, the user often has little control over the location in which they are situated. For example, the user may be required to go to work every day, even though they don't enjoy going to work and do not enjoy that particular area of the city. Therefore, even if advertisements transmitted to the user were to include content pertaining to the user's location, there is no guarantee that the user will find the advertisements of interest to him or her.

In accordance with various embodiments, information pertaining to physical entities with respect to a user may be collected. For example, the information may indicate a user reaction with respect to the physical entities. From this information, characteristics of the user may be deduced. Therefore, the system may generate or update a user profile based, at least in part, upon these characteristics. The system may then send information such as content or an advertisement to the user based, at least in part, upon the user profile.

In accordance with various embodiments, the user profile may identify physical entities that the user has an affinity toward. A user profile including information pertaining to the user's reaction to or affinity toward particular physical entities may be referred to as a “wish list.” Alternatively, the user profile may also include additional information such as that typically maintained in a user profile, in addition to the wish list, as described in further detail below.

Example System

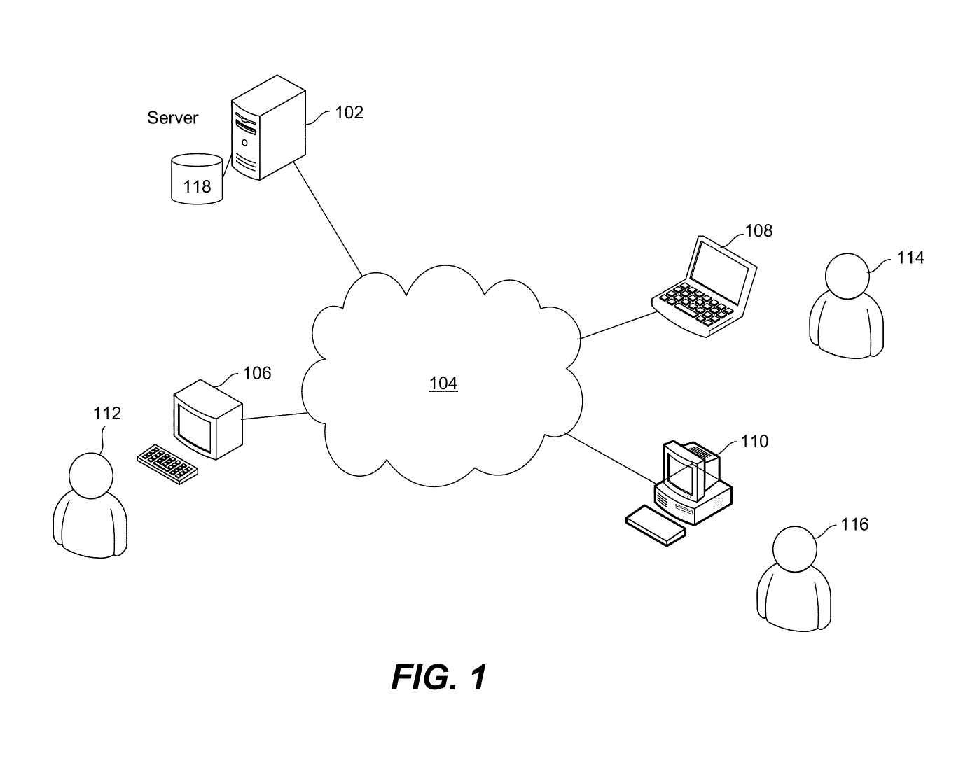

FIG. 1 is a diagram illustrating an example system in which embodiments of the invention may be implemented. As shown in FIG. 1, the system may include one or more servers 102 associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may maintain public user profiles, interact with other members of the web site, upload files (e.g., photographs, videos), etc.

In this example, the server(s) 102 may obtain or otherwise receive data (e.g., account data and/or user profile) and/or requests (e.g., search requests) via the Internet 104 from one or more computers 106, 108, 110 in association with corresponding entities 112, 114, 116, respectively. For example, each of the entities 112, 114, 116 may be an individual, a group of individuals (e.g., group, business or company), or other entity such as a web site. However, in order to simplify the description, the disclosed embodiments will be described with reference to individuals that are users of the web site.

The server(s) 102 may have access to one or more user logs 118 (e.g., user databases) into which user information is retained. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)). The user profile may include one or more wish lists, as will be described in further detail below. The user logs 118 may be retained in one or more memories that are coupled to the server 102.

The user information retained in the user logs 118 may include personal information such as demographic information (e.g., age and/or gender) and/or geographic information (e.g., residence address, work address, and/or zip code). In addition, each time a user performs online activities such as clicking on an advertisement or purchasing goods or services, information regarding such activity or activities may be retained as user data in the user logs 118. For instance, the user data that is retained in the user logs 118 may indicate the identity of web sites visited, identity of ads that have been selected (e.g., clicked on) and/or a timestamp. Moreover, where the online publisher supports a search engine (e.g., via the server 102 or a separate search server), information associated with a search query, such as search term(s) of the search query, information indicating characteristics of search results that have been selected (e.g., clicked on) by the user, and/or associated timestamp may also be retained in the user logs 118. A user may be identified in the user logs 118 by a user ID (e.g., user account ID), information in a user cookie, etc.

In one embodiment, as an individual interacts with a software application, e.g., an instant messenger or electronic mail application, descriptive content, such in the form of signals or stored physical states within memory, such as, for example, an email address, instant messenger identifier, phone number, postal address, message content, date, time, etc., may be identified. Descriptive content may be stored, typically along with contextual content. For example, how a phone number came to be identified (e.g., it was contained in a communication received from another via an instant messenger application) may be stored as contextual content associated with the phone number. Contextual content, therefore, may identify circumstances surrounding receipt of a phone number (e.g., date or time the phone number was received) and may be associated with descriptive content. Contextual content, may, for example, be used to subsequently search for associated descriptive content. For example, a search for phone numbers received from specific individuals, received via an instant messenger application or at a given date or time, may be initiated.

Content within a repository of media or multimedia, for example, may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, etc.

A profile builder may initiate generation of a profile, such for users of an application, including a search engine, for example. A profile builder may initiate generation of a user profile for use, for example, by a user, as well as by an entity that may have provided the application. For example, a profile builder may enhance relevance determinations and thereby assist in indexing, searching or ranking search results. Therefore, a search engine provider may employ a profile builder, for example.

A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

An online publisher (i.e., web publisher) will generally be responsible for delivering multiple advertisements via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

An advertisement may include content pertaining to a product or service, which may be delivered via the Internet, email, text message, or digital television. The content typically includes text. However, it is important to note that an advertisement may include text, one or more images, video, and/or audio. An advertisement may also include one or more hypertext links, enabling a user to proceed with the purchase of a particular product or service. In addition, an advertisement may include an offer pertaining to a product or service. For example, the offer may include a coupon or discount not otherwise available to users purchasing the product or service.

The disclosed embodiments enable content and/or advertisements to be identified, selected, generated, transmitted, and/or otherwise provided to users based, at least in part, upon a user profile generated or updated in accordance with the disclosed embodiments. More particularly, the server(s) 102 may provide content and/or advertisements to users via the web site (e.g., via display on a web page of the web site), via electronic mail, Short Message Service (SMS), via a mobile device (e.g., text message), or via another medium such as digital television, which may be connected to the Internet.

Where content or an advertisement is provided to a particular user, information pertaining to the content or advertisement (e.g., identifying a product or service advertised in the advertisement) may be stored in association with the user's account data. For example, information identifying an advertisement may be stored in association with the user's account data. In addition, the server(s) 102 may automatically collect online (and/or real world) behavioral data for any of users 112, 114, 116 to determine whether the advertisement was successful. In other words, the server(s) 102 may determine whether the user purchased the product or service advertised in the advertisement. Data indicating whether the advertisement was successful may be stored in association with the user's account data and/or the advertisement.

Advertising

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

Ad Networks/Exchanges

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

Ad Targeting

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Ad Serving

An “ad server” comprises a server that stores online advertisements for presentation to users. “Ad serving” refers to methods used to place online advertisements on websites, in applications, or other places where users are_more likely to see them, such as during an online session or during computing platform use, for example.

Ad Analytics

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

### Example Embodiments

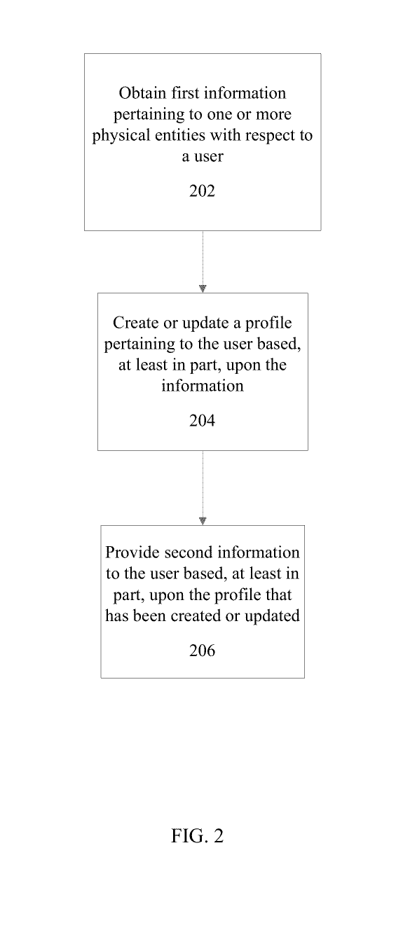

FIG. 2 is a process flow diagram illustrating an example method of implementing a wish list in accordance with various embodiments. The system (e.g., a network device) may obtain first information pertaining to one or more physical entities with respect to a user at 202. For example, the physical entities may include a physical location or a physical object.

A physical location may be a geographical area, a location identified by specific GPS coordinates, a business entity (e.g., airport or restaurant), an address, a building, landmark, etc. A geographical area may be defined by a street block, neighborhood (e.g., Times Square), city, state, an area defined by coordinates delineating the boundaries of the area, an area defined by boundaries selected on a map provided via a graphical user interface, etc.

A physical object may include an object that is immovable or fixed such as a house or tree. In addition, a physical object may include an object that may be located at a particular physical location, but is not necessarily fixed in its location. For example, a physical object may include a particular book, dress, or food item.

At least a portion of the first information may be obtained automatically by the system. For example, the system may analyze a set of data or files, such as a set of digital photographs and/or associated tags, via a social network such as Flickr. Thus, the first information may include visual information such as photographs and/or audio information. As another example, the system may automatically analyze physical surroundings via a device such as a mobile device to detect the first information. Thus, the first information may identify the user's location, which may include specific coordinates, or may generally identify a physical location (e.g., Yosemite) or type of physical location (e.g., national park). Mechanisms for determining a user's location will be described in further detail below.

In addition, at least a portion of the first information may be obtained based, at least in part, upon input received from the user. More particularly, the first information may indicate a positive or negative sentiment of the user toward at least one of the one or more physical entities or toward a type of at least one of the one or more physical entities. In accordance with various embodiments, the user may choose to add a particular physical entity to his or her “wish list.” This may enable the user to indicate, for example, that he or she wants a particular physical object or that he or she enjoys visiting a particular physical location. As another example, the first information may indicate a sentiment of the user toward a type of object or type of location, such as ice cream or ski slopes, respectively. Thus, a particular physical entity may be defined as a particular object, an object type, a location, and/or a location type.

In accordance with various embodiments, one or more photographs may be uploaded by the user and/or obtained automatically via the system. The photograph(s) may include a representation of at least one of the one or more physical entities. For example, a photograph may include a stack of books next to the user. Moreover, the photograph(s) may have been taken within or in proximity to the one or more physical entities. For example, a photograph of a painting may have been taken in Lake Tahoe. Thus, the system may automatically ascertain a physical location associated with the photograph when the photograph is taken or uploaded, thereby enabling the location to be identified in association with the uploaded photograph.

The photograph(s) may include the user, may have been taken by the user, and/or may have been uploaded by the user. The first information pertaining to photograph(s) with respect to a user may indicate whether the photograph(s) include the user, have been taken by the user and/or been uploaded by the user (e.g., in association with an account of the user). Furthermore, the first information may include or relate to one or more tags pertaining to at least one of the one or more photographs. More particularly, the tags may have been generated by the user, may identify the user, and/or may identify a particular physical entity associated with a particular photograph.

The system may create or update a profile pertaining to the user at 204 based, at least in part, upon the first information. More particularly, the system may store the first information and/or store results of analyzing the first information in a profile. The profile may include first information explicitly specified by the user (e.g., a user-specified affinity or dislike for a particular physical entity). In addition, the profile may include first information that has been automatically detected by the system (e.g., location). Moreover, the profile may include the results of analyzing the first information. For example, even where the user does not specify an affinity or dislike for a particular physical entity, the system may conclude that the user has an affinity or dislike for a particular physical entity based upon the first information.

In accordance with various embodiments, the system may analyze the content of photographs that have been uploaded by the user to a website such as Flickr (e.g., in association with the user's account). For example, the system may analyze the content of a photograph to identify physical entities such as books within a photograph and then record the identity of the books in the user profile. As another example, the system may ascertain the number of physical entities such as books within a photograph. As a result, the system may determine that the user enjoys reading based upon the number of books in the photograph, and indicate in the profile that the user enjoys reading. As yet another example, the system may ascertain the number of photographs that include a particular physical entity. Thus, the system may determine that where a particular physical entity is represented in a number of photographs that exceeds a particular threshold number, the user has an affinity toward that physical entity. For instance, where the user has uploaded more than 10 photographs of paintings, the system may ascertain that the user likes artwork.

In addition, the system may automatically analyze tags associated with photographs uploaded by the user to a website such as Flickr (e.g., in association with the user's account). For example, the system may identify those photographs in which the user is tagged. As another example, the system may identify locations that are specified in tags.

The profile or portion thereof may operate as a user wish list. More particularly, the profile may include a list of physical entities that the user has specified that they like or would like to own or visit. The profile may further identify those physical entities that the user has specified that they dislike. The profile may further operate in a broader sense to indicate those physical entities that the system has concluded that the user likes (and/or dislikes).

Once generated, the wish list may identify a plurality of physical entities, as well as additional information such as user sentiment with respect to each of the plurality of physical entities. Each of the physical entities may be identified by or associated with location information. For example, the location information may indicate a location (e.g., city, state, country, etc.) and/or type of location (e.g., park). Furthermore, the user may maintain multiple wish lists, where each wish list is associated with a different location, enabling the user to generate a location-based wish list. Thus, at least a portion of a user profile may be associated with a location.

The system may provide second information to the user at 206 based, at least in part, upon the profile that has been created or updated. More particularly, the second information may include content such as an article. Alternatively, the second information may include an advertisement. For example, the system may identify and provide content that pertains to at least one of the physical entities that the user has an affinity toward. As another example, the system may provide an advertisement that pertains to at least one of the physical entities that the user has an affinity toward.

In accordance with various embodiments, each advertisement may be associated with one or more physical entities based upon a bid submitted by the advertiser. The advertiser may indicate in the bid that they would like the advertisement to be provided to individuals who have an affinity toward at least one of the physical entities. Alternatively, the advertiser may indicate in the bid that they would like the advertisement to be provided to individuals having an affinity toward each of the physical entities specified in the bid. The bid may further indicate a target profile specifying additional characteristics of those individuals who are to receive the advertisement. Thus, an advertisement may be associated with one or more physical entities. Similarly, a physical entity may be associated with a set of one or more advertisements.

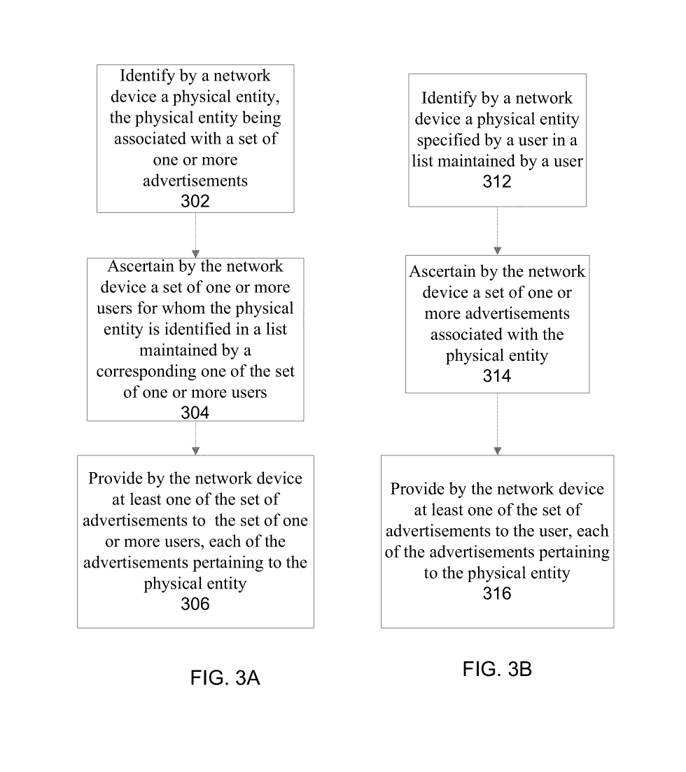

FIGS. 3A-3B are process flow diagrams illustrating example methods of serving advertisements according to user wish lists in accordance with various embodiments. As shown in FIG. 3A, a network device may identify a physical entity, where the physical entity is associated with a set of one or more advertisements at 302. For example, the system may maintain a list of physical entities for which advertisements are to be provided. Each of these advertisements may be mapped to one or more physical entities. Similarly, each of the physical entities may be mapped to a set of one or more advertisements.

The network device may ascertain a set of one or more users for whom the physical entity is identified in a list maintained by the corresponding one of the set of one or more users at 304. More particularly, each of the users may maintain a list that is stored or otherwise accessible by the network device. The list may be a wish list listing physical entities that have been added to the list by the user (and/or automatically added by the system). This list may include physical entities that the user wishes to receive, purchase, or visit. Similarly, the list may include physical entities that the user enjoys or has an affinity toward.

The network device may provide at least one of the set of advertisements to the set of one or more users, where each of the advertisements pertains to the physical entity at 306. More particularly, the system may identify a mapping that maps the physical entity to a set of one or more advertisements, and ascertain the set of one or more advertisements that correspond to the physical entity from this mapping.

As shown in FIG. 3B, a network device may identify a physical entity specified by a user in a list maintained by a user at 312. More particularly, the list may be a wish list listing physical entities that have been added to the list by the user (and/or have been automatically added by the system). This list may include physical entities that the user wishes to receive, purchase, or visit. Similarly, the list may include physical entities that the user enjoys or has an affinity toward.

The network device may ascertain a set of one or more advertisements associated with the physical entity at 314. More particularly, the system may identify a mapping that maps the physical entity to a set of one or more advertisements, and ascertain the set of one or more advertisements that correspond to the physical entity from this mapping. The network device may provide at least one of the set of advertisements to the user at 316, where each of the advertisements pertains to the physical entity.

Although FIGS. 3A and 3B pertain to the serving of advertisements, it is important to note that the disclosed embodiments may also be implemented to serve other forms of content. Therefore, the disclosed embodiments may be applied to serve a variety of content based, at least in part, upon information in a wish list.

The price that an advertiser is charged for providing an advertisement may be based upon one or more factors. More particularly, the price may be based, at least in part, upon the number of advertisements associated with the physical entity. For example, where the set of advertisements associated with a particular physical entity includes a single advertisement, the charge may be higher than where the set of advertisements includes a large number of advertisements. In addition, the price may be based, at least in part, on the number of users predicted to have the particular physical entity on their wish list.

In accordance with various embodiments, a user may opt-in to the system for providing wish-list-based advertising. More particularly, as a result of opting-in, the system may monitor the wish list of the user, enabling the user to receive advertisements or other content associated therewith based, at least in part, upon the user's wish list. The user may receive various benefits as a result of opting in. For example, the user may receive monetary payment, discounts, or other services in return for the user opting in to the system.

Bidding and Bidding Platform

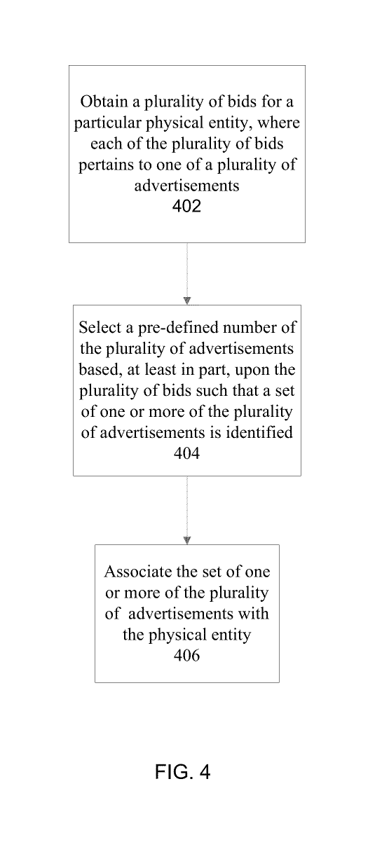

Mappings between advertisements and corresponding physical entities may be generated as a result of a bidding or auctioning process. FIG. 4 is a process flow diagram illustrating an example method of auctioning physical entities in accordance with various embodiments. The system may obtain a plurality of bids for a particular physical entity at 402, where each of the plurality of bids pertains to one of a plurality of advertisements. The system may select a pre-defined number of the plurality of advertisements based, at least in part, upon the plurality of bids such that a set of one or more of the plurality of advertisements is identified at 404. Each of the plurality of bids may pertain to an exclusive right for the set of one or more advertisements to be provided to users having the physical entity on their wish list (or identified in their profile). The system may associate the set of one or more of the plurality of advertisements with the physical entity at 406. For example, the system may store information mapping the set of advertisements to the physical entity. This mapping information may enable advertisements to be indexed by physical entity, as well as enable physical entities to be indexed by advertisement.

The embodiments described with reference to FIG. 4 refer to a set of advertisements associated with a physical entity. However, it is important to note that an advertisement may have associated therewith more than one physical entity. In addition, the system may maintain mappings for a plurality of physical entities. Therefore, the auctioning process described herein may be performed for each one of the plurality of physical entities.

In accordance with various embodiments, a Bidding Platform may enable bids to be placed on any of a plurality of physical entities (e.g., objects and/or locations) in association with an advertisement. A bid may therefore be placed on a physical entity by selecting the corresponding physical entity from a plurality of physical entities. Alternatively, a physical entity such as a location may be defined as a result of the bidding process. For example, a bidder may define and select a particular geographic area using a map that is presented via a graphical user interface. In this manner, an advertiser or may place a bid on a particular location (e.g., geographic area).

In addition, the system may provide information pertaining to physical entities (e.g., locations and/or physical objects) tracked by the system via a graphical user interface to potential advertisers via the Bidding Platform. More particularly, the information provided may include a number of users that have an affinity toward a particular physical entity. This number may be provided as a single number over a period of time, or may be provided for incremental periods over time.

The Bidding Platform may further provide a price (or minimum price) associated with a particular physical entity via a graphical user interface to potential advertisers via the Bidding Platform. For example, the price may be a single price to be paid for the right to provide advertisements to users having an affinity toward the physical entity over a particular period of time. As another example, the price may be a price per impression to be charged each time an advertisement is provided to a user.

Signals Indicating Current User Location

User location(s) of a user may be identified based upon one or more signals (i.e., data). For example, the user's location may be ascertained and associated with a photograph taken by the user at the location. Each of the signals may be obtained from one or more data sources. Example signals will be described in further detail below.

The user's current location may be identified based upon traditional mechanisms such as IP address and/or GPS location. Other mechanisms for tracking a user's location include applications such as Glympse, which enables a user to share his or her location. In addition, the user's location may be ascertained based upon check-in information. More particularly, a user may choose to check in to a particular establishment or event via an application such as Foursquare, Messenger, or Bubbles. Such a check-in application may be implemented on a web site and/or a mobile device. Thus, the user's current location may be determined based upon the location of the establishment or event. More particularly, an event may be scheduled to occur at a particular location at an associated time (e.g., date, start time, length, and/or time period). For example, an event may be defined by an associated location and expected time that the event is to occur. Example events may include, but are not limited to, a baseball game, concert, etc.

Such a check-in application may be implemented on a web site and/or a mobile device. Alternatively, a signal of the user's current location may be ascertained via a device such as a mobile device. For example, the mobile device may detect the user's location via a GPS or Internet Protocol (IP) Address. The user may also take explicit action to store their current location using an application on a device such as a mobile device.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Network Architecture

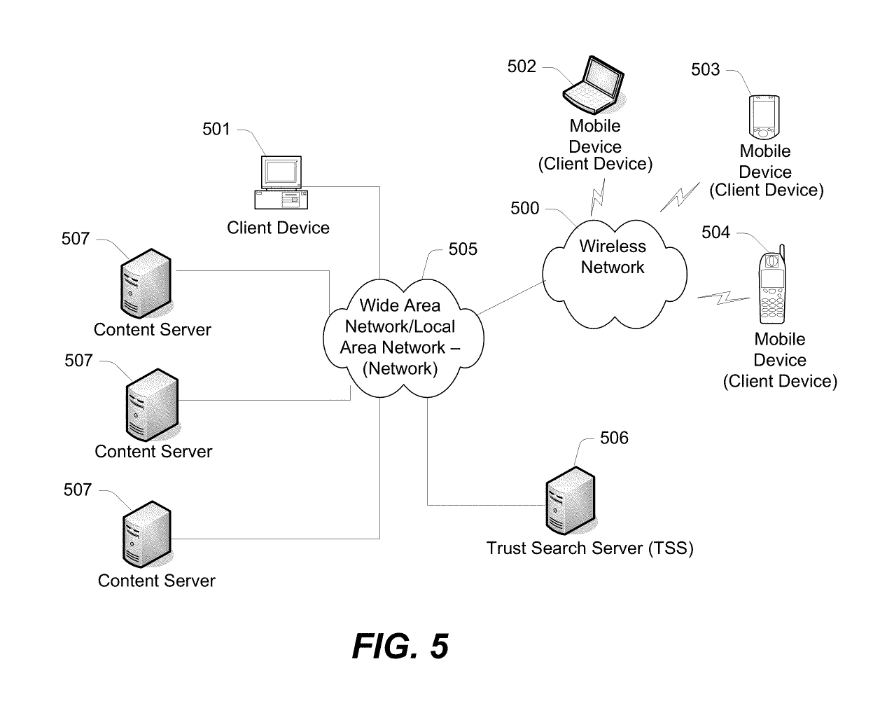

The disclosed embodiments may be implemented in any of a wide variety of computing contexts. FIG. 5 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 5, for example, includes a variety of networks, such as a LAN/WAN 505 and wireless network 500, a variety of devices, such as client devices 501-504, and a variety of servers such as content server(s) 507 and search server 506. The servers may also include an ad server (not shown). As shown in this example, the client devices 501-504 may include one or more mobile devices 502, 503, 504. Client device(s) 501-504 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

User wish lists may be implemented to facilitate the serving of advertisements or content according to the disclosed embodiments in some centralized manner. This is represented in FIG. 5 by content server(s) 507, which may correspond to multiple distributed devices and data store(s). The content server(s) 507 and/or corresponding data store(s) may store user account data and/or preferences, user wish lists (e.g., indicating preferences and/or dislikes), advertisements, advertisement-physical entity mappings, and/or information pertaining to bids.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

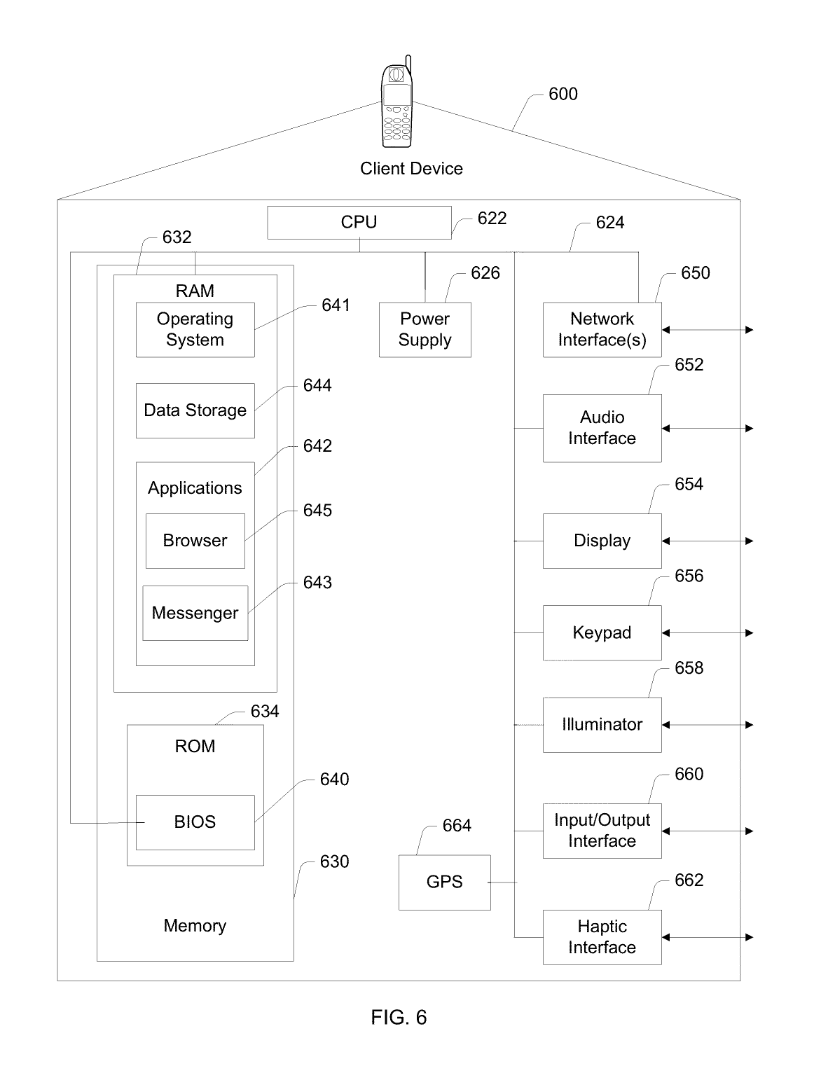

FIG. 6 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

As shown in this example, a client device 600 may include one or more central processing units (CPUs) 622, which may be coupled via connection 624 to a power supply 626 and a memory 630. The memory 630 may include random access memory (RAM) 632 and read only memory (ROM) 634. The ROM 634 may include a basic input/output system (BIOS) 640.

The RAM 632 may include an operating system 641. More particularly, a client device may include or may execute a variety of operating systems, including a personal computer operating system, such as a Windows, iOS or Linux, or a mobile operating system, such as iOS, Android, or Windows Mobile, or the like. The client device 600 may also include or may execute a variety of possible applications 642 (shown in RAM 632), such as a client software application such as messenger 643, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 600 may also include or execute an application to communicate content, such as, for example, textual content, multimedia content, or the like, which may be stored in data storage 644. A client device may also include or execute an application such as a browser 645 to perform a variety of possible tasks, such as browsing, searching, playing various forms of content, including locally stored or streamed video, or games (such as fantasy sports leagues).

The client device 600 may send or receive signals via one or more interface(s). As shown in this example, the client device 600 may include one or more network interfaces 650. The client device 600 may include an audio interface 652. In addition, the client device 600 may include a display 654 and an illuminator 658. The client device 600 may further include an Input/Output interface 660, as well as a Haptic Interface 662 supporting tactile feedback technology.

The client device 600 may vary in terms of capabilities or features. Claimed subject matter is intended to cover a wide range of potential variations. For example, a cell phone may include a keypad such 656 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 664 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

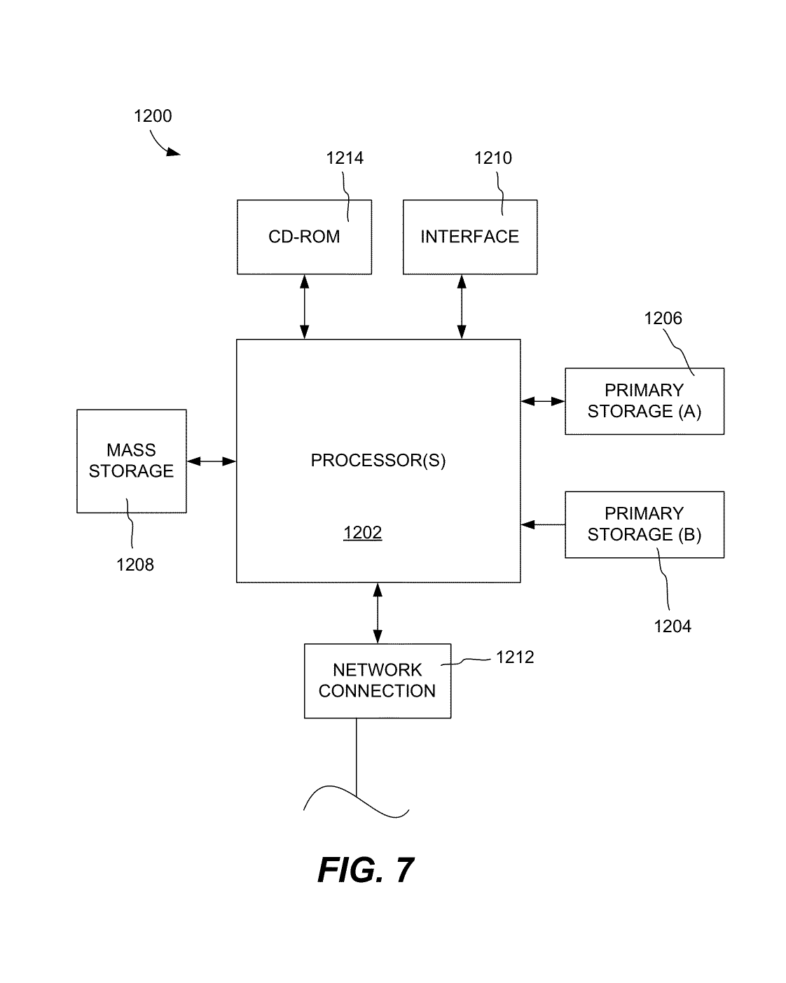

FIG. 7 illustrates a typical computer system that, when appropriately configured or designed, can serve as a system of this invention. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
obtaining first information pertaining to one or more physical entities with respect to a user;
creating or updating a profile pertaining to the user based, at least in part, upon the first information; and
providing second information to the user based, at least in part, upon the profile that has been created or updated.

2. The method as recited in claim 1, wherein the one or more physical entities comprise at least one of a physical location or a physical object.

3. The method as recited in claim 1, wherein the first information indicates a positive or negative sentiment of the user toward at least one of the one or more physical entities or toward a type of at least one of the one or more physical entities.

4. The method as recited in claim 1, wherein obtaining the first information comprises receiving input from the user.

5. The method as recited in claim 1, wherein the first information comprises visual information.

6. The method as recited in claim 1, wherein the first information comprises one or more photographs that include at least one of the one or more physical entities or that have been taken in proximity to at least one of the one or more physical entities.

7. The method as recited in claim 6, wherein at least one of the one or more photographs includes the user, has been taken by the user, or has been uploaded by the user.

8. The method as recited in claim 6, wherein the first information further comprises one or more tags pertaining to at least one of the one or more photographs.

9. The method as recited in claim 8, wherein the one or more tags have been generated by the user.

10. The method as recited in claim 8, wherein the one or more tags identify the user.

11. An apparatus, comprising:
a processor; and
a memory, at least one of the processor or the memory being adapted for:
obtaining first information pertaining to one or more physical entities with respect to a user;
creating or updating a profile pertaining to the user based, at least in part, upon the first information; and
providing second information to the user based, at least in part, upon the profile that has been created or updated.

12. The method as recited in claim 11, wherein the second information comprises content.

13. The method as recited in claim 11, wherein the second information comprises an advertisement or offer.

14. The apparatus as recited in claim 13, at least one of the processor or the memory being further adapted for performing steps, further comprising:
receiving a bid pertaining to at least one of the one or more physical entities, wherein the bid is associated with the advertisement or offer.

15. A non-transitory computer-readable medium storing thereon computer-readable instructions, comprising:
instructions for obtaining first information pertaining to one or more physical entities with respect to a user;
instructions for creating or updating a profile pertaining to the user based, at least in part, upon the first information; and
instructions for providing second information to the user based, at least in part, upon the profile that has been created or updated.

16. The non-transitory computer-readable medium as recited in claim 15, wherein the one or more physical entities comprise at least one of a physical location or a physical object.

17. The non-transitory computer-readable medium as recited in claim 15, wherein the first information indicates a positive or negative sentiment of the user toward at least one of the one or more physical entities or toward a type of at least one of the one or more physical entities.

18. The non-transitory computer-readable medium as recited in claim 15, wherein obtaining the first information comprises receiving input from the user.

19. The non-transitory computer-readable medium as recited in claim 15, wherein the profile is associated with a location.

20. The non-transitory computer-readable medium as recited in claim 15, wherein the first information comprises one or more photographs that include at least one of the one or more physical entities or that have been taken in proximity to at least one of the one or more physical entities.
